(19) United States
(12) Patent Application Publication
(10) Pub. No.: US 2022/0195893 A1
(43) Pub. Date: Jun. 23, 2022

(54) DEVICE FOR FASTENING SEALING PLATES BETWEEN COMPONENTS OF A GAS TURBINE ENGINE

(71) Applicant: Rolls-Royce Deutschland Ltd & Co KG, Blankenfelde-Mahlow (DE)

(72) Inventor: Thomas SCHIESSL, Rangsdorf (DE)

(21) Appl. No.: 17/442,888

(22) PCT Filed: Mar. 23, 2020
(86) PCT No.: PCT/EP2020/058021

§ 371 Date: Sep. 24, 2021

(30) Foreign Application Priority Data
Mar. 29, 2019 (DE) 10 2019 108 267.6

(51) Int. Cl. F01D 25/24; F01D 11/00

(52) U.S. Cl. CPC F01D 25/246; F01D 11/12; F01D 25/243; F01D 11/006

(57) ABSTRACT

A device for fastening sealing plates between components of a gas turbine engine includes guide vane ring which includes guide vane segments, wherein each guide vane segment includes an outer platform and an inner platform, sealed off from one another at ends by a sealing strip. The device furthermore includes a plurality of sealing plates which seal off the guide vane segments from a component which is adjacent in the upstream or downstream direction. The sealing strips in each case form a sealing section and an extension section, wherein the sealing section serves to seal off two mutually adjoining platforms, the extension section extends axially forward or axially rearward, starting from the sealing section, and projects from the platforms, and the extension section forms a holding element for at least one sealing plate or is connected to a separate holding element.

The invention relates to a device for fastening sealing plates between components of a gas turbine engine.

There is a known practice of arranging sealing plates between components of a gas turbine engine, said plates delimiting a flow path through the gas turbine engine and following one another in the axial direction. Here, the sealing plates extend in the circumferential direction and seal off a gap between the axially successive components from the gas flowing in the flow path.

DE 11 2008 003 522 T5, for example, discloses the practice of fastening the sealing plates by means of rivets which pass through the sealing plates, are secured on one of the components and are preloaded by means of spring elements. The disadvantage here is that it is necessary in each case to provide a gap between the rivets and the sealing plate in order to ensure freedom of movement for the sealing plate. Such a gap is a source of additional leaks. Moreover, the structure known from DE 11 2008 003 522 T5 is relatively complex and heavy owing to the number of parts involved.

It is the underlying object of the invention to provide a device for fastening sealing plates between components of a gas turbine engine which is of simple construction and avoids or at least reduces the formation of leaks at the sealing plates.

This object is achieved by a device having the features of claim 1 and by a device having the features of claim 18. Refinements of the invention are indicated in the dependent claims.

Accordingly, the invention relates in a first aspect of the invention to a device for fastening sealing plates between components of a gas turbine engine which has a guide vane ring and a plurality of sealing plates. The guide vane ring comprises a plurality of guide vane segments, wherein each guide vane segment comprises an outer platform, an inner platform and at least one guide vane. The outer platforms and the inner platforms of in each case two adjacent guide vane segments adjoin one another at the ends. In this arrangement, in each case two platforms are sealed off from one another at the ends by means of a sealing strip. For this purpose, the platforms each form an axially extending groove at their ends, wherein the sealing strip is inserted into the grooves of the platforms. The sealing strip extends in the grooves from the axially forward end of the platforms to the axially rearward end of the platforms, ensuring that there is effective sealing.

The sealing plates seal off the guide vane segments from a component which adjoins the guide vane segments in the upstream or downstream direction. In particular, the sealing plates seal off a gap between the component which is adjoining in the upstream or downstream direction and the guide vane segments.

It is envisaged that the sealing strips in each case form a sealing section and an extension section in the region of the outer and/or the inner platforms, wherein the sealing section serves to seal off two mutually adjoining platforms. The extension section extends axially forward, starting from the sealing section, wherein the adjoining component is arranged upstream, and projects from the platforms. It forms a holding element for at least one sealing plate or is connected to a separate holding element.

Accordingly, the invention is based on the concept of developing a component element that is present in any case, namely the sealing strip which in each case seals off two platforms of the guide vane ring from one another at the ends, in such a way that the sealing strip forms the holding element for the sealing plates or is connected to such a holding element. This gives rise to a simple construction since it is possible to dispense with separate parts, such as rivets and spring elements. Moreover, since it is not necessary to provide the holding elements with fastening holes for rivets, leakage of the sealing plates is also prevented or at least reduced. In this case, the sealing strip is extended axially forward to form an extension section, wherein the extension section projects from the platforms and in each case holds at least one sealing plate directly or via a separate holding element.

Another advantage associated with the invention is that, because the retention of the sealing plates is not achieved by means of rivets on the guide vane segment, the handling and exchange of sealing plates can take place more simply and more quickly.

The feature that the sealing strip extends in the grooves from the axially forward end of the platforms to the axially rearward end of the platforms should be understood to mean that the grooves and the sealing strips arranged therein extend over the majority of the axial length of the platforms, particularly in the axial region in which they adjoin a guide vane. The grooves do not necessarily extend from the axially forwardmost point to the axially rearwardmost point of the platforms. The axial length of the extent is sufficient to achieve the required sealing function between two mutually adjoining platforms.

It is envisaged that the platforms each form an axially extending groove at their ends. In this context, one embodiment envisages that the sealing section of a sealing strip is in each case inserted into the grooves of two adjacent platforms. The extension section projects from the grooves in the downstream direction, wherein it assumes the additional functionality of holding one or more sealing plates. Here, the sealing section of the sealing strip corresponds to a conventional sealing strip which, once arranged in the grooves of two platforms adjoining one another at the ends, seals off said platforms from one another.

Another embodiment of the invention envisages that the extension section is of wider design in the circumferential direction than the sealing section. As a result, the extension section is of more stable design and, in this improved form, it can fit around and hold two sealing plates adjoining one another in the circumferential direction.

Another embodiment envisages that the extension section forms a section which extends substantially in the radial direction and in the circumferential direction, is of flat design and forms a holding element. A large-area structure which enables one or more sealing plates to be fastened or retained in an effective manner is thereby provided,

To fasten one or more sealing plates, provision can be made for the extension section to form a groove which extends in the circumferential direction and is used to retain and accommodate at least one adjoining sealing plate. Such a groove is formed, for example, if the extension section has a section which extends in the radial direction and in the circumferential direction and is bent back at its radially outer end and thereby forms a groove. In this case, the end section is preferably bent over in the direction of the adjoining component. The end section fits over the radially outer rim of one or more sealing plates in the region of the groove, and said plates are thereby held on the extension section

One embodiment thereof envisages that the extension section has a length in the circumferential direction such that two adjacent sealing plates can be inserted into the groove of the extension section. As a result, the extension section connects in an effective manner two sealing plates which adjoin one another in the circumferential direction which are both held by means of the groove on the extension section, Here, a gap present between the mutually adjoining sealing plates is covered by the extension section, thus ensuring that there is no leakage caused by such a gap.

As already mentioned, the extension section itself can form the holding element for at least one sealing plate. In alternative embodiments, it is envisaged that a separate holding part is provided for in each case at least one sealing plate. In this case, the extension section is connected to such a holding element designed as a separate part.

One embodiment thereof envisages that the separate holding element forms a section which extends substantially in the radial direction and in the circumferential direction, is of flat design and is bent back at its radially outer end and thereby forms a groove extending in the circumferential direction.

According to one embodiment of the invention, it is envisaged that the extension section is of resilient design and exerts a spring force on at least one of the sealing plates, thereby pressing the latter against the adjoining component to be sealed. In this way, the extension section itself is used to provide a contact pressure by means of which the sealing plates are pressed against flanges, projecting noses or other structures of the respective components. In this context, attention is drawn to the fact that the sealing plates seal off any gap with respect to an adjoining component in an effective manner by virtue of the fact that they are pressed against corresponding structures of the guide vane segment and of the adjoining component during operation of the gas turbine engine owing to a pressure difference. It is advantageous here to provide a spring force by means of which the sealing plates are pressed against the adjoining component in order to position the sealing plates in a suitable manner and, in particular, to prevent the sealing plate from being positioned at a distance from the component to be sealed off, even in the case where there is no pressure difference (during the starting process, for example). Alternatively, provision can be made for the sealing plate to be held with an axial play by the extension section.

To obtain a spring force provided by the extension section, it is envisaged in the exemplary embodiments that the extension section forms a region bent in a U shape or a region bent in a meandering shape, in which the extension section is bent backward and forward once or several times. Such a region bent in a meandering shape may also be referred to as a bellows.

The design of the extension section with a spring force applies both to embodiments in which the extension section itself in each case serves as a holding element for at least one sealing plate and to embodiments in which the extension section is connected to a separate holding element for at least one sealing plate, in the latter case, the extension section of resilient design exerts an axially acting spring force on the separate holding element. In this case, the extension section of resilient design exerts on the separate holding element a spring force which acts in an axially forward direction, wherein the adjoining component to be sealed is arranged upstream of the guide vane segments.

Another embodiment of the invention envisages that radial noses which fix the sealing plates in the circumferential direction in relation to the holding elements are formed on said sealing plates. Here, the radial noses define the extent to which the sealing plates can be inserted into the respective holding element in the circumferential direction or are surrounded by said holding element. Accordingly, they are formed at a distance from the ends of the sealing plates and rest externally against the respectively adjacent holding element in the circumferential direction.

In principle, the present invention can be used at any desired point in a gas turbine at which the sealing plates are fastened on guide vane segments. An exemplary use consists in the sealing of a gap by sealing plates, said gap being formed between the combustion chamber and an adjoining high-pressure turbine in a gas turbine engine. In this case, the guide vane ring is designed as a turbine guide vane ring, and the sealing plates are designed to seal off the turbine guide vane ring from the combustion chamber arranged upstream.

In principle, the sealing strips can be composed of any desired material. In some embodiments, they are composed of a metal or a metal alloy, e.g. a nickel-based alloy, e.g. a cobalt-nickel-chromium-tungsten alloy. The sealing plates are designed as sheet metal parts, for example.

According to a second aspect of the invention, the present invention relates to a device for fastening sealing plates between components of a gas turbine engine which has a guide vane ring and a plurality of sealing plates. The guide vane ring comprises a plurality of guide vane segments, wherein each guide vane segment comprises an outer platform, an inner platform and at least one guide vane. The outer platforms and the inner platforms of in each case two adjacent guide vane segments adjoin one another at the ends. In this arrangement, in each case two platforms are sealed off from one another at the ends by means of a sealing strip. For this purpose, the platforms each form an axially extending groove at their ends, wherein the sealing strip is inserted into the grooves of the platforms. The sealing strip extends in the grooves from the axially forward end of the platforms to the axially rearward end of the platforms, ensuring that there is effective sealing.

The sealing plates seal off the guide vane segments from a component which adjoins the guide vane segments in the upstream or downstream direction. In particular, the sealing plates seal off a gap between the component which is adjoining in the upstream or downstream direction and the guide vane segments.

It is envisaged that a respective fastening element for at least one sealing plate is provided in the region of the outer and/or the inner platforms, wherein the fastening element holds the at least one sealing plate or is connected to a separate holding element, which holds the at least one sealing plate. The fastening element comprises:
a fastening section, which is arranged together with the sealing strip in the grooves of two adjacent platforms and is held in said grooves, and
a holding section, which extends axially forward, starting from the fastening section, and projects from the platforms in order to hold the at least one sealing plate or to be connected to the separate holding element.

According to the second aspect of the invention, it is thus envisaged that the fastening element for the at least one sealing plate (which holds the sealing plate or is connected thereto directly or via a separate holding element) represents a part which is separate from the sealing strip and is not formed, as in the first aspect of the invention, by an extension section of the sealing strip. In this case, the holding section of the fastening element, together with the sealing strip, rests in the grooves formed at the ends of the mutually adjoining platforms. By being arranged in the grooves, it is prevented from falling out. In this case, provision can be made for the holding section to be held positively and/or nonpositively in the grooves.

In this respect, one embodiment envisages that the fastening section is arranged only in an axially forward partial region of the grooves, i.e. does not extend over the entire axial length of the grooves. In this case, provision can furthermore be made for the axially forward partial region of the groove to be widened relative to a downstream region of the grooves. By virtue of the widening of the groove, the sealing strip and the holding section of the fastening element can be arranged in contact with one another in the grooves without problems.

Another embodiment envisages that the holding section is of resilient design and exerts a spring force directly on at least one of the sealing plates. Alternatively, provision can be made for the holding section to be of resilient design and to exert a spring force on a separate holding element which holds the at least one sealing plate.

To provide a spring force, the holding section can form a region bent in a U shape or a region bent in a meandering shape, for example.

Further embodiments of the second aspect of the invention can be designed in accordance with claims 2-17 relating to the first aspect of the invention, wherein the holding section of the second aspect of the invention corresponds to the extension section of the first aspect of the invention, and the fastening section of the second aspect of the invention corresponds to the sealing section of the first aspect of the invention. Thus, for example, provision can be made for the holding section to be of wider design in the circumferential direction than the fastening section.

In another aspect of the invention, the present invention relates to a gas turbine engine which comprises a combustion chamber and a turbine guide vane ring arranged downstream of the combustion chamber. In this case, it is envisaged that the gas turbine engine comprises a device according to the invention by means of which sealing plates provided between the combustion chamber and the turbine guide vane ring are fastened.

It is pointed out that the present invention is described with reference to a cylindrical coordinate system which has the coordinates x, r, and φ. Herein x indicates the axial direction, r indicates the radial direction, and φ indicates the angle in the circumferential direction. The axial direction herein is defined by the machine axis of the gas turbine engine in which the present invention is implemented, wherein the axial direction is that from the engine inlet in the direction of the engine outlet. Proceeding from the x-axis, the radial direction points radially outward. Terms such as “in front of”, “behind”, “front”, and “rear” refer to the axial direction, or the flow direction in the engine. Terms such as “outer” or “inner” relate to the radial direction.

As noted elsewhere herein, the present disclosure may relate to a gas turbine engine. Such a gas turbine engine may comprise an engine core which comprises a turbine, a combustion chamber, a compressor, and a core shaft that connects the turbine to the compressor. Such a gas turbine engine may comprise a fan (having fan blades) which is positioned upstream of the engine core.

Arrangements of the present disclosure can be particularly, although not exclusively, beneficial for fans that are driven via a gear box. Accordingly, the gas turbine engine may comprise a gear box that receives an input from the core shaft and outputs drive for the fan so as to drive the fan at a lower rotational speed than the core shaft. The input to the gear box may be performed directly from the core shaft or indirectly from the core shaft, for example via a spur shaft and/or a spur gear. The core shaft may be rigidly connected to the turbine and the compressor, such that the turbine and the compressor rotate at the same rotational speed (wherein the fan rotates at a lower rotational speed).

The gas turbine engine as described and/or claimed herein may have any suitable general architecture. For example, the gas turbine engine may have any desired number of shafts, for example one, two or three shafts, that connect turbines and compressors. Purely by way of example, the turbine connected to the core shaft may be a first turbine, the compressor connected to the core shaft may be a first compressor, and the core shaft may be a first core shaft. The engine core may further comprise a second turbine, a second compressor, and a second core shaft which connects the second turbine to the second compressor. The second turbine, second compressor and second core shaft may be arranged so as to rotate at a higher rotational speed than the first core shaft.

In such an arrangement, the second compressor may be positioned so as to be axially downstream of the first compressor. The second compressor may be arranged so as to receive (for example directly receive, for example via a generally annular duct) flow from the first compressor.

The gear box may be arranged so as to be driven by that core shaft (for example the first core shaft in the example above) which is configured to rotate (for example during use) at the lowest rotational speed, For example, the gear box may be arranged so as to be driven only by that core shaft (for example only by the first core shaft, and not the second core shaft, in the example above) which is configured to rotate (for example during use) at the lowest rotational speed. Alternatively thereto, the gear box may be arranged so as to be driven by one or a plurality of shafts, for example the first and/or the second shaft in the example above.

In the case of a gas turbine engine as described and/or claimed herein, a combustion chamber may be provided axially downstream of the fan and of the compressor(s). For example, the combustion chamber can lie directly downstream of the second compressor (for example at the exit of the latter), if a second compressor is provided. By way of further example, the flow at the exit of the compressor may be supplied to the inlet of the second turbine, if a second turbine is provided. The combustion chamber may be provided upstream of the turbine(s).

The or each compressor (for example the first compressor and the second compressor as described above) may comprise any number of stages, for example multiple stages. Each stage may comprise a row of rotor blades and a row of stator blades, which may be variable stator blades (in the sense that the angle of incidence of said variable stator blades may be variable). The row of rotor blades and the row of stator blades may be axially offset from one another.

The or each turbine (for example the first turbine and the second turbine as described above) may comprise any number of stages, for example multiple stages. Each stage may comprise a row of rotor blades and a row of stator blades. The row of rotor blades and the row of stator blades may be axially offset from one another.

Each fan blade may be defined as having a radial span extending from a root (or a hub) at a radially inner location flowed over by gas, or at a 0% span width position, to a tip at a 100% span width position. The ratio of the radius of the fan blade at the hub to the radius of the fan blade at the tip may be less than (or of the order of): 0.4, 0.39, 0.38, 0.37, 0.36, 0.35, 0.34, 0.33, 0.32, 0.31, 0.3, 0.29, 0.28, 0.27, 0.26 or 0.25. The ratio of the radius of the fan blade at the hub to the radius of the fan blade at the tip may be in an inclusive range delimited by two of the values in the previous sentence (that is to say that the values may form upper or lower limits). These ratios may be referred to in general as the hub-to-tip ratio. The radius at the hub and the radius at the tip can both be measured at the leading periphery part (or the axially frontmost periphery) of the blade. The hub-to-tip ratio refers, of course, to that portion of the fan blade which is flowed over by gas, that is to say the portion that is situated radially outside any platform.

The radius of the fan can be measured between the engine centerline and the tip of the fan blade at the leading periphery of the latter. The diameter of the fan (which can simply be double the radius of the fan) may be larger than (or of the order of): 250 cm (approximately 100 inches), 260 cm, 270 cm (approximately 105 inches), 280 cm (approximately 110 inches), 290 cm (approximately 115 inches), 300 cm (approximately 120 inches), 310 cm, 320 cm (approximately 125 inches), 330 cm (approximately 130 inches), 340 cm (approximately 135 inches), 350 cm, 360 cm (approximately 140 inches), 370 cm (approximately 145 inches), 380 cm (approximately 150 inches), or 390 cm (approximately 155 inches). The fan diameter may be in an inclusive range delimited by two of the values in the previous sentence (that is to say that the values may form upper or lower limits).

The rotational speed of the fan may vary during use. Generally, the rotational speed is lower for fans with a comparatively large diameter. Purely by way of non-limiting example, the rotational speed of the fan under cruise conditions may be less than 2500 rpm, for example less than 2300 rpm. Purely by way of a further non-limiting example, the rotational speed of the fan under cruise conditions for an engine having a fan diameter in the range from 250 cm to 300 cm (for example 250 cm to 280 cm) may also be in the range from 1700 rpm to 2500 rpm, for example in the range from 1800 rpm to 2300 rpm, for example in the range from 1900 rpm to 2100 rpm. Purely by way of a further non-limiting example, the rotational speed of the fan under cruise conditions for an engine having a fan diameter in the range from 320 cm to 380 cm may be in the range from 1200 rpm to 2000 rpm, for example in the range from 1300 rpm to 1800 rpm, for example in the range from 1400 rpm to 1600 rpm.

During use of the gas turbine engine, the fan (with associated fan blades) rotates about an axis of rotation. This rotation results in the tip of the fan blade moving with a velocity Utip. The work done by the fan blades on the flow results in an enthalpy rise dH in the flow. A fan tip loading can be defined as dH/Utip2, where dH is the enthalpy rise (for example the 1-D average enthalpy rise) across the fan and Utip is the (translational) velocity of the fan tip, for example at the leading periphery of the tip (which can be defined as the fan tip radius at the leading periphery multiplied by the angular velocity). The fan tip loading at cruise conditions may be more than (or of the order of): 0.3, 0.31, 0.32, 0.33, 0.34, 0.35, 0.36, 0.37, 0.38, 0.39, or 0.4 (wherein all units in this passage are Jkg-1K-1/(ms-1)2). The fan tip loading may be in an inclusive range delimited by two of the values in the previous sentence (that is to say that the values may form upper or lower limits).

Gas turbine engines in accordance with the present disclosure can have any desired bypass ratio, where the bypass ratio is defined as the ratio of the mass flow rate of the flow through the bypass duct to the mass flow rate of the flow through the core at cruise conditions. In the case of some arrangements, the bypass ratio can be more than (or of the order of): 10, 10.5, 11, 11.5, 12, 12.5, 13, 13.5, 14, 14.5, 15, 15.5, 16, 16.5, or 17. The bypass ratio may be in en inclusive range delimited by two of the values in the previous sentence (that is to say that the values may form upper or lower limits). The bypass duct may be substantially annular. The bypass duct may be situated radially outside the engine core. The radially outer surface of the bypass duct may be defined by an engine nacelle and/or a fan casing.

The overall pressure ratio of a gas turbine engine as described and/or claimed herein can be defined as the ratio of the stagnation pressure upstream of the fan to the stagnation pressure at the exit of the highest pressure compressor (before entry into the combustion chamber). As a non-limiting example, the overall pressure ratio of a gas turbine engine as described and/or claimed herein at cruising speed may be greater than (or of the order of): 35, 40, 45, 50, 55, 60, 65, 70, 75. The overall pressure ratio may be in an inclusive range delimited by two of the values in the previous sentence (that is to say that the values may form upper or lower limits).

The specific thrust of an engine can be defined as the net thrust of the engine divided by the total mass flow through the engine The specific thrust of an engine as described and/or claimed herein at cruise conditions may be less than (or of the order of): 110 Nkg-1 s, 105 Nkg-1 s, 100 Nkg-1 s, 95 Nkg-1 s, 90 Nkg-1 s, 85 Nkg-1 s or 80 Nk-1 s. The specific thrust may be in an inclusive range delimited by two of the values in the previous sentence (that is to say that the values may form upper or lower limits). Such engines can be particularly efficient in comparison with conventional gas turbine engines.

A gas turbine engine as described and/or claimed herein may have any desired maximum thrust. Purely by way of a non-limiting example, a gas turbine as described and/or claimed herein may be capable of generating a maximum thrust of at least (or of the order of): 160 kN, 170 kN, 180 kN, 190 kN, 200 kN, 250 kN, 300 kN, 350 kN, 400 kN, 450 kN, 500 kN, or 550 kN. The maximum thrust may be in an inclusive range delimited by two of the values in the previous sentence (that is to say that the values may form upper or lower limits). The thrust referred to above may be the maximum net thrust at standard atmospheric conditions at sea level plus 15 degrees C. (ambient pressure 101.3 kPa, temperature 30 degrees C.) in the case of a static engine.

During use, the temperature of the flow at the entry to the high-pressure turbine can be particularly high. This temperature, which can be referred to as TET, may be measured at the exit to the combustion chamber, for example directly upstream of the first turbine blade, which in turn can be referred to as a nozzle guide vane. At cruising speed, the TET may be at least (or of the order of): 1400 K, 1450 K, 1500 K, 1550 K, 1600 K, or 1650 K. The TET at constant speed may be in an inclusive range delimited by two of the values in the previous sentence (that is to say that the values may form upper or lower limits). The maximum TET in the use of the engine may be at least (or of the order of), for example: 1700 K, 1750 K, 1800 K, 1850 K, 1900 K, 1950 K. or 2000 K. The maximum TET may be in an inclusive range delimited by two of the values in the previous sentence (that is to say that the values may form upper or lower limits) The maximum TET may occur, for example, under a high thrust condition, for example under a maximum take-off thrust (MTO) condition.

A fan blade and/or an airfoil portion of a fan blade described and/or claimed herein may be manufactured from any suitable material or a combination of materials. For example, at least a part of the fan blade and/or of the airfoil can be manufactured at least in part from a composite, for example a metal matrix composite and/or an organic matrix composite, such as carbon fiber. By way of further example, at least a part of the fan blade and/or of the airfoil can be manufactured at least in part from a metal, such as a titanium-based metal or an aluminum-based material (such as an aluminum-lithium alloy) or a steel-based material. The fan blade may comprise at least two regions which are manufactured using different materials. For example, the fan blade may have a protective leading periphery, which is manufactured using a material that is better able to resist impact (for example of birds, ice, or other material) than the rest of the blade. Such a leading periphery may, for example, be manufactured using titanium or a titanium-based alloy. Thus, purely by way of example, the fan blade may have a carbon-fiber-based or aluminum-based body (such as an aluminum-lithium alloy) with a titanium leading periphery.

A fan as described and/or claimed herein may comprise a central portion, from which the fan blades may extend, for example in a radial direction. The fan blades may be attached to the central portion in any desired manner. For example, each fan blade may comprise a fixing device which can engage with a corresponding slot in the hub (or disk). Purely by way of example, such a fixing device may be in the form of a dovetail that can be inserted into and/or engage with a corresponding slot in the hub/disk in order for the fan blade to be fixed to the hub/disk. By way of further example, the fan blades can be formed integrally with a central portion. Such an arrangement may be referred to as a blisk or a bling. Any suitable method may be used to manufacture such a blisk or such a bling. For example, at least some of the fan blades can be machined from a block and/or at least some of the fan blades can be attached to the hub/disk by welding, such as linear friction welding, for example.

The gas turbine engines described and/or claimed herein may or may not be provided with a variable area nozzle (VAN). Such a variable area nozzle can allow the exit cross section of the bypass duct to be varied during use. The general principles of the present disclosure can apply to engines with or without a VAN.

The fan of a gas turbine as described and/or claimed herein may have any desired number of fan blades, for example 16, 18, 20 or 22 fan blades.

As used herein, cruise conditions can mean cruise conditions of an aircraft to which the gas turbine engine is attached. Such cruise conditions can be conventionally defined as the conditions at mid-cruise, for example the conditions experienced by the aircraft and/or the engine between (in terms of time and/or distance) the top of climb and the start of descent.

Purely by way of example, the forward speed at the cruise condition can be any point in the range of from Mach 0.7 to 0.9, for example 0.75 to 0.85, for example 0.76 to 0.84, for example 0.77 to 0.83, for example 0.78 to 0.82, for example 0.79 to 0.81, for example of the order of Mach 0.8, of the order of Mach 0.85 or in the range of from 0.8 to 0.85. Any arbitrary speed within these ranges can be the constant cruise condition. In the case of some aircraft, the constant cruise conditions may be outside these ranges, for example below Mach 0.7 or above Mach 0.9.

Purely by way of example, the cruise conditions may correspond to standard atmospheric conditions at an altitude that is in the range from 10,000 m to 15,000 m, for example in the range from 10,000 m to 12,000 m, for example in the range from 10,400 m to 11,600 m (around 38,000 ft), for example in the range from 10,500 m to 11,500 m, for example in the range from 10,600 m to 11,400 m, for example in the range from 10,700 m (around 35,000 ft) to 11,300 m, for example in the range from 10,800 m to 11,200 m, for example in the range from 10,900 m to 11,100 m, for example of the order of 11,000 m. The cruise conditions may correspond to standard atmospheric conditions at any given altitude in these ranges.

Purely by way of example, the cruise conditions may correspond to the following: a forward Mach number of 0.8; a pressure of 23,000 Pa; and a temperature of −55 degrees C.

As used anywhere herein, “cruising speed” or “cruise conditions” may mean the aerodynamic design point. Such an aerodynamic design point (or ADP) may correspond to the conditions (including, for example, the Mach number, environmental conditions, and thrust requirement) for which the fan operation is designed. This may mean, for example, the conditions under which the fan (or the gas turbine engine) has the optimum efficiency in terms of construction.

In use, a gas turbine engine described and/or claimed herein can operate at the cruise conditions defined elsewhere herein. Such cruise conditions can be determined by the cruise conditions (for example the mid-cruise conditions) of an aircraft to which at least one (for example 2 or 4) gas turbine engine can be fastened in order to provide the thrust force.

It is self-evident to a person skilled in the art that a feature or parameter described in relation to one of the above aspects may be applied to any other aspect, unless these are mutually exclusive. Furthermore, any feature or any parameter described here may be applied to any aspect and/or combined with any other feature or parameter described here, unless these are mutually exclusive.

The invention will be explained in more detail below on the basis of a plurality of exemplary embodiments with reference to the figures of the drawing. In the drawing:

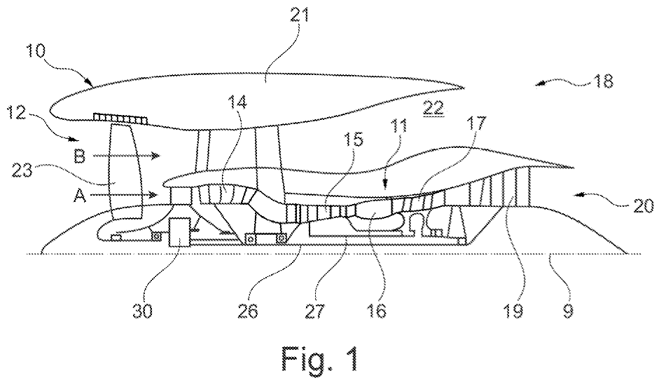

FIG. 1 shows a lateral sectional view of a gas turbine engine;

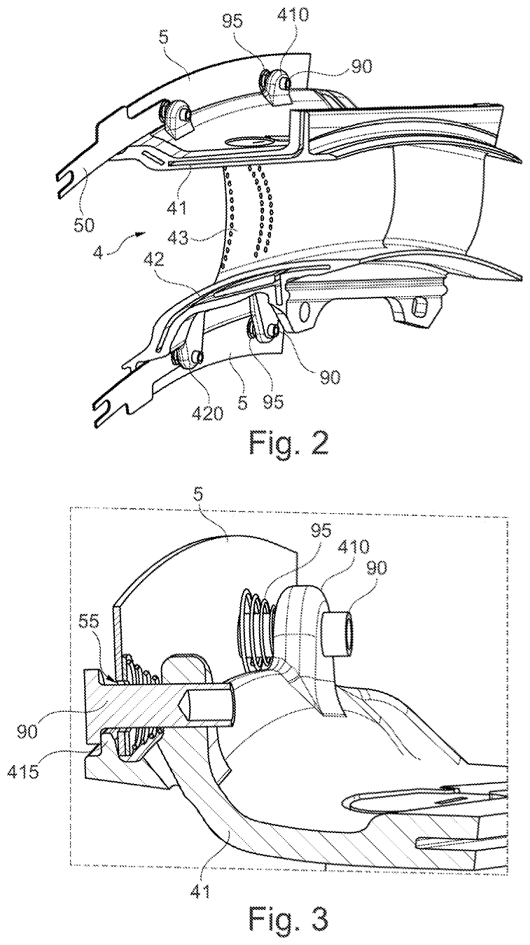

FIG. 2 shows an embodiment of a turbine guide vane segment according to the prior art, wherein an outer platform and an inner platform of the turbine guide vane segment are sealed off from an adjoining combustion chamber by means of sealing plates;

FIG. 3 shows a partially sectioned view of the turbine guide vane segment of FIG. 2;

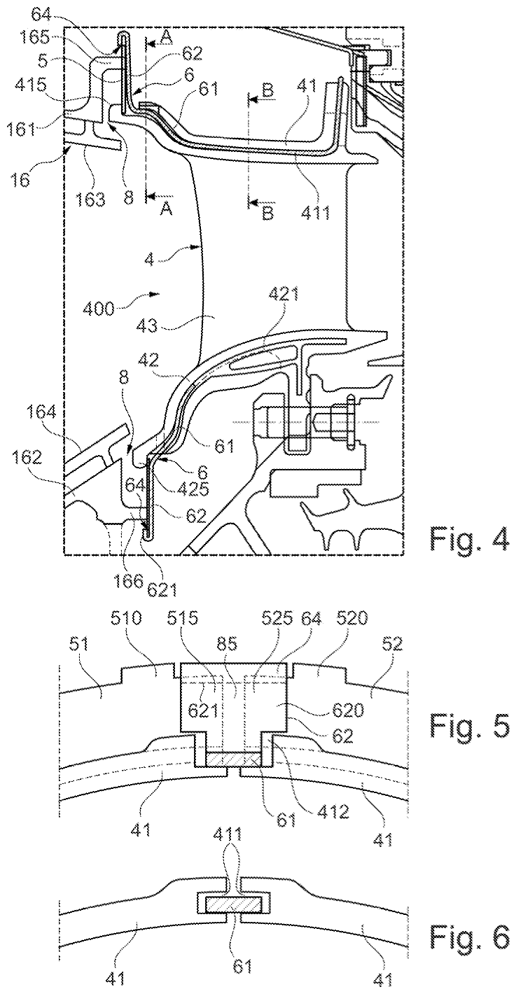

FIG. 4 shows a sectional illustration of a turbine guide vane segment of a guide vane ring of a high-pressure compressor, which is implemented in the main flow path, adjoining the combustion chamber, wherein the turbine guide vane segment comprises a device for fastening sealing plates between the turbine guide vane segment and the combustion chamber, said device comprising a sealing strip which forms an extension section for fastening sealing plates;

FIG. 5 shows a section through the turbine guide vane segment of FIG. 4 along the line A-A in FIG. 4;

FIG. 6 shows a section through the turbine guide vane segment of FIG. 4 along the line B-B in FIG. 4;

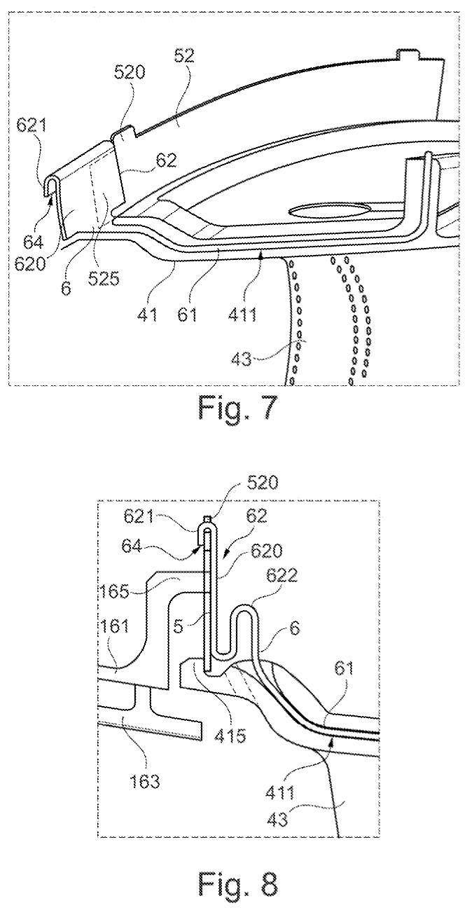

FIG. 7 shows a perspective illustration of the sealing strip of the device for fastening sealing plates between the turbine guide vane segment and the combustion chamber according to FIG. 4;

FIG. 8 shows an alternative embodiment of the extension section of the sealing strip of FIG. 4, wherein the extension section forms a spring region that is bent backward and forward in a meandering shape,

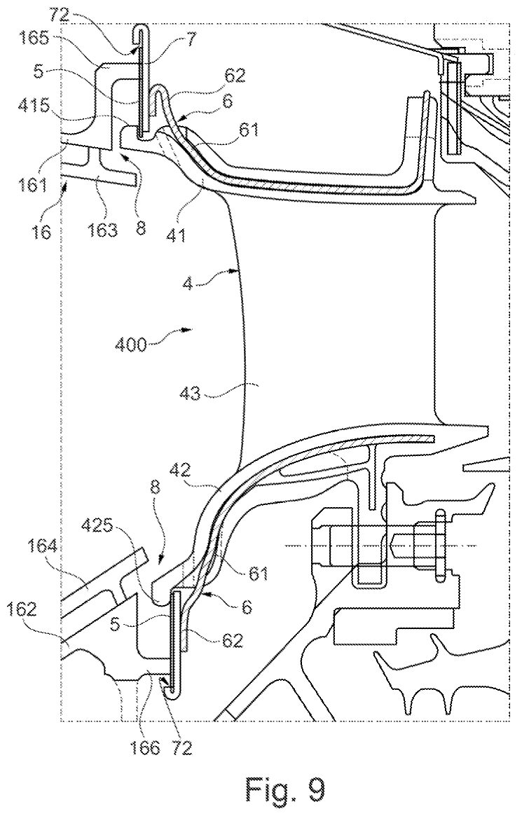

FIG. 9 shows a sectional illustration of another turbine guide vane segment of a guide vane ring of a high-pressure compressor, which is implemented in the main flow path, adjoining the combustion chamber, wherein, for the purpose of fastening sealing plates between the turbine guide vane segment and the combustion chamber, the turbine guide vane segment comprises a sealing strip having an extension section which is connected to a separate holding element for fastening sealing plates;

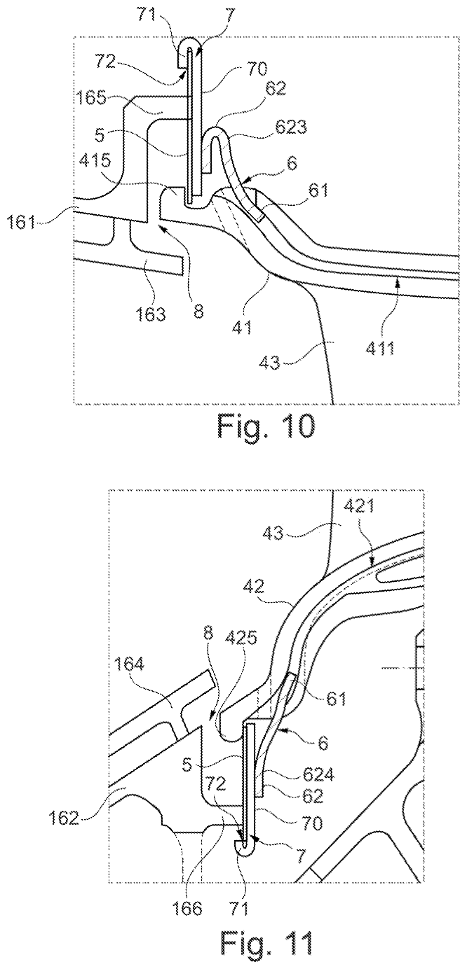

FIG. 10 shows the extension section and the holding element on the radially outer platform of the turbine guide vane segment of FIG. 9 on an enlarged scale;

FIG. 11 shows the extension section and the holding element on the radially inner platform of the turbine guide vane segment of FIG. 9 on an enlarged scale; and

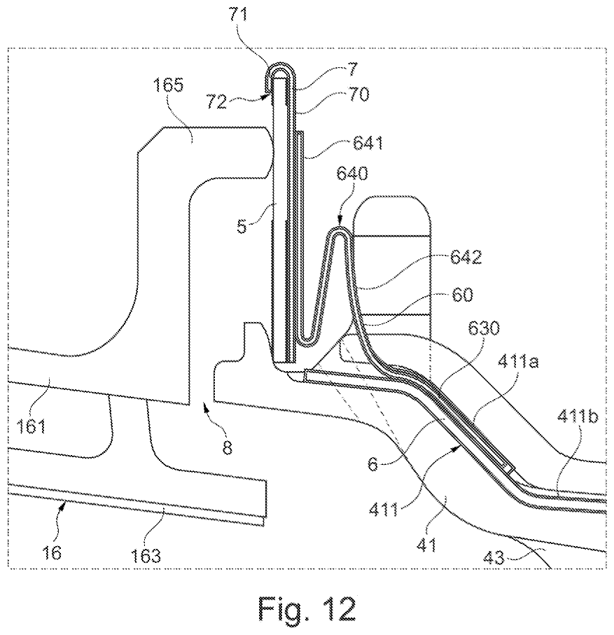

FIG. 12 shows another exemplary embodiment of a turbine guide vane segment of a guide vane ring of a high-pressure compressor, wherein the turbine guide vane segment comprises a device for fastening sealing plates between the turbine guide vane segment and the combustion chamber, said device comprising a fastening element which forms a fastening section and a holding section.

FIG. 1 illustrates a gas turbine engine 10 having a main axis of rotation 9. The engine 10 comprises an air intake 12 and a thrust fan 23 that generates two air flows: a core air flow A and a bypass air flow B. The gas turbine engine 10 comprises a core 11 which receives the core air flow A. In the sequence of axial flow, the engine core 11 comprises a low-pressure compressor 14, a high-pressure compressor 15, a combustion device 16, a high-pressure turbine 17, a low-pressure turbine 19, and a core thrust nozzle 20. An engine nacelle 21 surrounds the gas turbine engine 10 and defines a bypass duct 22 and a bypass thrust nozzle 18. The bypass air flow B flows through the bypass duct 22. The fan 23 is attached to and driven by the low-pressure turbine 19 by way of a shaft 26 and an epicyclic gear box 30,

During use, the core air flow A is accelerated and compressed by the low-pressure compressor 14 and directed into the high-pressure compressor 15, where further compression takes place. The compressed air expelled from the high-pressure compressor 15 is directed into the combustion device 16, where it is mixed with fuel and the mixture is combusted. The resulting hot combustion products then propagate through the high-pressure and the low-pressure turbines 17, 19 and thereby drive said turbines, before being expelled through the nozzle 20 to provide a certain propulsive thrust. The high-pressure turbine 17 drives the high-pressure compressor 15 by means of a suitable connecting shaft 27. The fan 23 generally provides the major part of the thrust force. The epicyclic gear box 30 is a reduction gear box.

It is noted that the terms “low-pressure turbine” and “low-pressure compressor” as used herein can be taken to mean the lowest pressure turbine stage and the lowest pressure compressor stage (that is to say not including the fan 23) respectively and/or the turbine and compressor stages that are connected to one another by the connecting shaft 26 with the lowest rotational speed in the engine (that is to say not including the gear box output shaft that drives the fan 23). In some documents, the “low-pressure turbine” and the “low-pressure compressor” referred to herein may alternatively be known as the “intermediate-pressure turbine” and “intermediate-pressure compressor”. Where such alternative nomenclature is used, the fan 23 can be referred to as a first compression stage or lowest-pressure compression stage.

Other gas turbine engines in which the present disclosure can be used may have alternative configurations. For example, such engines may have an alternative number of compressors and/or turbines and/or an alternative number of connecting shafts. By way of a further example, the gas turbine engine shown in FIG. 1 has a split flow nozzle 20, 22, meaning that the flow through the bypass duct 22 has its own nozzle that is separate from and radially outside the core engine nozzle 20. However, this is not restrictive, and any aspect of the present disclosure can also apply to engines in which the flow through the bypass duct 22 and the flow through the core 11 are mixed or combined before (or upstream of) a single nozzle, which may be referred to as a mixed flow nozzle. One or both nozzles (whether mixed or split flow) can have a fixed or variable area. Although the example described relates to a turbofan engine, the disclosure can be applied, for example, to any type of gas turbine engine, such as, for example, an open rotor engine (in which the fan stage is not surrounded by an engine nacelle) or a turboprop engine. In some arrangements, the gas turbine engine 10 may not comprise a gear box 30.

The geometry of the gas turbine engine 10, and components thereof, is/are defined by a conventional axis system, comprising an axial direction (which is aligned with the axis of rotation 9), a radial direction (in the bottom-to-top direction in FIG. 1), and a circumferential direction (perpendicular to the view in FIG. 1). The axial, radial and circumferential directions run so as to be mutually perpendicular.

In the context of the present invention, the design of the transition between the combustion chamber 16 and the high-pressure turbine 17, in particular the configuration of the sealing of a gap between the combustion chamber 16 and the high-pressure turbine 17, are significant.

For a better understanding of the invention, the background of the invention will first of all be explained by means of an example of a turbine guide vane segment according to the prior art, which is illustrated in FIGS. 2 and 3. The turbine guide vane segment 4 comprises an outer platform 41, an inner platform 42 and one or more guide vanes 43, which extend in the radial direction between the inner platform 42 and the outer platform 41. A plurality of such turbine guide vane segments 4 forms a turbine guide vane ring, wherein the individual turbine guide vane segments 4 adjoin one another in the circumferential direction at the ends of their platforms 41, 42.

To seal off a radial gap which is formed as a matter of necessity between the combustion chamber 16 and the turbine guide vane segments 4, a plurality of sealing plates 5, which are each of elongate design and form a circular arc, is provided. As can be seen, in particular, from the illustration in FIG. 3, the sealing plates 5 are held by means of rivets 90 fastened on fastening projections 410, 420 of the respective platform 41, 42 and are provided with a contact pressure by means of spring elements 95. In this case, the rivets 90 pass through the sealing plates 5 in a respective fastening hole. The sealing plates 5 are pressed against the combustion chamber by means of the spring elements 95 and are supported on structures 415 of the turbine guide vane segments 4, ensuring in this way that the gap between the combustion chamber and the turbine guide vane segments 4 is sealed off by the sealing plates 5. However, leakage arises from gaps 55 which are formed between each of the rivets 90 and the fastening holes in the sealing plates 5. Moreover, the figure illustrates what is referred to as a secondary sealing plate 50, which covers a gap between two sealing plates 5 adjoining one another in the circumferential direction and thereby reduces leakage due to such a gap.

The prior art device for fastening the sealing plates 5 is relatively complex and heavy since separate rivets 90, spring elements 95 and fastening projections 410, 420 have to be provided. At the same time, it is not possible, owing to the gaps 55 and the associated leakage, for the radial gap between the combustion chamber 16 and the turbine guide vane ring to be sealed off completely. In order to avoid additional leakage through radial gaps situated between two mutually adjoining sealing plates 5, additional secondary sealing plates 50 are required.

FIG. 4 shows, in a sectional illustration, a subsection of the core engine of a gas turbine engine, wherein—in relation to the flow direction—the illustrated subsection shows the rear section of a combustion chamber 16 and a turbine guide vane segment 4 of a turbine guide vane ring 400 directly adjoining the combustion chamber 16. The turbine guide vane ring 400 is segmented and comprises a plurality of turbine guide vane segments 4, which adjoin one another in the circumferential direction.

The combustion chamber 16 comprises an outer combustion chamber wall 161 and an inner combustion chamber wall 162, wherein the terms “outer” and “inner” refer to the main flow path which runs through the core engine. For protection against the hot gas flow in the combustion chamber 16, the outer combustion chamber wall 161 is provided with a plurality of heat shingles 163, which are supported on the outer combustion chamber wall 161. In corresponding fashion, the inner combustion chamber wall 162 is provided with a plurality of heat shingles 164, which are supported on the inner combustion chamber wall 162.

The outer combustion chamber wall 161 forms part of an outer combustion chamber casing, of which a further wall structure 165 is illustrated. The inner combustion chamber wall 162 forms part of an inner combustion chamber casing, which likewise comprises further wall structures, of which a further wall structure 166 is illustrated.

Each turbine guide vane segment 4 of the turbine guide vane ring 400 comprises an outer platform 41, which delimits the main flow path through the core engine radially on the outside, an inner platform 42, which delimits the main flow path through the core engine radially on the inside, and at least one guide vane 43, which extends between the inner platform 42 and the outer platform 41. The outer platforms 41 of the turbine guide vane segments 4 and the inner platforms 42 of the turbine guide vane segments 4 together form an outer platform and an inner platform of the guide vane ring 400.

A groove 411, 421 extending substantially in the axial direction is formed in the end both of the radially outer platform 41 and of the radially inner platform 42. The grooves 411, 421 each serve to accommodate a sealing section 61, which likewise extends substantially in the axial direction in the grooves 411, 421 and thereby seals off two radially inner platforms 42 and two radially outer platforms 41 resting against one another at the ends. In this arrangement, the grooves 411, 421 and the sealing sections 61 arranged therein extend from the axially forward end of the platform 41, 42 to the axially rearward end of the platform 41, 42, ensuring that two platforms resting against one another at the ends are sealed off from one another in an effective manner. Such grooves 411,421 and sealing sections 61 arranged therein are known per se.

According to the exemplary embodiment in FIG. 4, unlike in the prior art, the sealing sections 61 are not sealing strips that extend completely in the grooves 411, 421. On the contrary, the sealing strips 6 provided form two sections, sealing section 61 and, in addition, an extension section 62, which, starting from the sealing section 61, extends axially forward and projects from the platforms 41, 42. In this case, it is envisaged that the extension section 62 forms a holding element for at least one sealing plate 5, which serves to seal off a radial gap 8 between the combustion chamber 16 and the guide vane segments 4.

Thus, the gap 8 between the combustion chamber 16 and the guide vane segments 4 is closed by a multiplicity of sealing plates 5. Each sealing element 5 is of elongate design and forms a circular arc. At end faces which are farmed in the circumferential direction at each end of a sealing element 5, two sealing elements 5 adjoin one another.

Here, it can be seen in FIG. 4 that each sealing element 5 adjoins a flange or a nose 415, 425 of the respective platform 41, 42 and the end face of a wall structure 165, 166 of the respective combustion chamber casing, as a result of which the gap 8 is closed both on the radially outer side and on the radially inner side.. In this arrangement, the sealing elements 5 are subject to a contact pressure which presses them against the structures 415, 425, 165, 166.

The retention of the sealing elements 5 and the generation of a contact pressure is accomplished by means of the extension section 62 of the sealing strip 6. In order to explain the design of the extension section 62, reference is additionally made to FIGS. 5, 6 and 7, wherein FIGS. 5 and 6 show sectional illustrations along the lines A-A and B-B of FIG. 4, and FIG. 7 is a perspective illustration of an outer platform 41, including a sealing strip 6 and a sealing element 5. The following statements apply in corresponding fashion to the radially inner platform 42 and to the sealing strip 6 formed there.

As can be seen from the sectional illustration in FIG. 6, the sealing section 61 of the sealing strip 6 extends at the ends, between two platforms 41 adjoining one another in the circumferential direction, in the grooves 411 of the two mutually adjoining platforms 41. Toward the axially forward end of the grooves 411, these merge into upwardly open recesses 412, thus enabling the sealing strip to emerge radially outward from the grooves 411. The sealing strip 6 then forms the extension section 62, which serves for the retention of the respective ends of two mutually adjoining sealing plates 5 and for the provision of a contact pressure.

In this case, it is envisaged that the extension section 62 is of wider design in the circumferential direction than the sealing section 61, as is readily apparent in the illustration in FIG. 5. It can furthermore be seen, particularly in FIGS. 5 and 7, that the extension section 62 forms a section 620 which extends substantially in the radial direction and in the circumferential direction, is of flat design and is bent back radially, namely=in the direction of the combustion chamber 16, at its radially outer end, in a section 621, to form a groove 64.

The two end sections 515, 525 of two adjacent sealing plates 51, 52 are inserted into the groove 64 and are held there at their upper edge. Adjoining the structure 415, the lower edge of the sealing plates 51, 52 rests on the radially outer platform 41. By virtue of the widening of the extension section 62, this section here forms a stable structure for the reception of the ends 515, 525 of two sealing plates 5 adjoining one another in the circumferential direction.

Attention is drawn to the fact that, because the extension section 62 covers a gap 85 formed between the ends of two adjacent sealing plates 51, 52, cf. FIG. 5, it is not necessary to use secondary sealing plates corresponding to the sealing plates 50 of the prior art in FIG. 2 to avoid additional leakage through such a gap 85.

In order to ensure exact positioning of the sealing plates 51, 52 relative to the extension section 62 designed as a holding element, the sealing plates 51, 52 have radially projecting noses 510, 520, cf. FIGS. 5 and 7. In this case, a radially projecting nose 510, 520 adjoins the extension section 62 in the circumferential direction. The noses 510, 520 define the region 515, 525 of the sealing plates 51, 52 which is inserted into the groove 64 of the extension section 62 and is held by the extension section 62.

Attention is drawn to the fact that the extension section 62 is of resilient design and accordingly simultaneously forms a spring element which transmits a contact pressure to the sealing plates 51, 52, even when there is no pressure difference.

In this respect, FIG. 8 shows an exemplary embodiment in which an additional spring force for the provision of a contact pressure is provided by means of an additional, meandering region 622 of the extension section 62. Here, the meandering region 622 (bellows) adjoins the sealing section 61 of the sealing strip 6 and, at its other end, merges into the section 620 extending substantially in the radial direction and in the circumferential direction. As in the exemplary embodiment in FIGS. 4-7, a groove 64 for the reception of the adjacent ends of two sealing plates 5 is formed here by means of a bent-over end section 621. In this respect, reference is made to the description of FIGS. 4-7.

FIGS. 9-11 show an alternative exemplary embodiment, which differs from the exemplary embodiments in FIGS. 4 to 8 in that the extension section 62 of the sealing strip 6 does not itself form a holding element for the sealing plates 5 but is instead connected to a holding element designed as a separate part. As regards the general construction of the combustion chamber 16, of the guide vane segments 4 and of the sealing plates 5, attention is drawn to the description of FIGS. 4 to 8.

As in the exemplary embodiments of FIGS. 4 to s, the sealing strip 6 is formed by two sections, a sealing section 61, which serves to seal off two mutually adjoining platforms 41, and an extension section 62, which is of shorter design however. As illustrated in FIGS. 9 and 10, the extension section 62 is formed in a U shape in the case of the outer platform 41, wherein the bent-back end of the U-shaped section 623 is connected to a separate holding element 7. The bent-back end of the U-shaped section 623 is brazed or welded to the holding element 7, for example.

In terms of its shape and holding function, the holding element 7 corresponds to sections 620, 621 of the holding element 62 in FIGS. 4 to 8. Thus, the holding element 7 comprises a section 70 which extends substantially in the radial direction and in the circumferential direction, is of flat design and is bent back at its radially outer end, in a section 71, in order thereby to form a groove 72 extending in the circumferential direction. The two mutually adjoining ends of two sealing plates 5 are inserted into the groove 72, with the result that they are held in the groove 72. Here, a contact pressure is provided by means of the extension section 62.

As illustrated in FIGS. 9 and 11, the extension section 62 in the case of the inner platform 42 is designed to extend substantially radially, wherein the end section 624 of the extension section is once again connected to a separate holding part 7. The connection is made by brazing or welding, for example. The design of the holding part 7 is as explained with reference to FIG. 10.

Attention is drawn to the fact that, just as in the other figures, the sealing section 61 in FIGS. 10 and 11 extends over the entire length of the grooves 411, 421 and not just over the short section illustrated.

FIG. 12 shows an alternative exemplary embodiment of a device for fastening sealing plates, which differs from the exemplary embodiments in FIGS. 4 to 11 in that the holding element for the sealing plate 5 is not provided by an extension section of a sealing strip but by a separate fastening element 60 which comprises a fastening section 630 and a holding section 640.

The general construction of the device corresponds to that in FIG. 4, wherein sealing plates 5 seal off a gap 8 which is formed between a combustion chamber 16 having an outer combustion chamber wall 161, heat shingles 163 and a wall structure 165, on the one hand, and an outer platform 41 having an end groove 411 and a sealing strip 6 arranged therein, on the other hand.

The fastening section 630 of the fastening element 60 is arranged in the groove 411 of the outer platform 41 (and a corresponding groove in the end of the adjacent platform), together with the sealing strip 6. In this case, the groove 411 has an axially forward partial region 411a which is widened relative to a partial region 411b, downstream thereof, of the groove 411. The sealing strip 6 and the fastening section 630 are arranged in contact with one another in the widened groove 411a. The fastening section 630 is prevented from falling out through its arrangement in the widened groove 411a. In this case, there can be nonpositive engagement through static friction of the fastening section 630 with respect to the wall of the groove 411a and with respect to the sealing strip 6. In addition, there can also be positive engagement by means of a curved shape of the groove 411a in the region in which the fastening section 630 is arranged.

Starting from the fastening section 630, the holding section 640 of the fastening element 60 extends axially forward and, at the same time, projects from the platform 41. In this case, the holding section 640 forms a first section 641, which is connected to a separate holding element 7 (being brazed or welded, for example), and a second section 642, which exerts a spring force on the separate holding element 7. For this purpose, the section 642 is designed to be curved in a meandering shape. The section 642 merges into the fastening section 630.

As in the exemplary embodiment in FIGS. 9-11, the holding element 7 comprises a section 70 which extends substantially in the radial direction and in the circumferential direction, is of flat design and is bent back at its radially outer end, in a section 71, in order thereby to form a groove 72 extending in the circumferential direction. Two mutually adjoining ends of the two sealing plates 5 are inserted into the groove 72.

In a manner corresponding to the embodiment in FIGS. 5 and 7, the holding section 640 of the fastening element 60 can be designed to be wider in the circumferential direction than the fastening section 630.

In the exemplary embodiment in FIG. 12, it is envisaged that the fastening element 60 is connected to a separate holding element 7, which holds the sealing plate 5, corresponding to the construction in FIGS. 9-11. As an alternative, however, it is also possible to provide a construction as per FIGS. 4-8, in which case the holding section 640 of the fastening element 60 is connected directly to the sealing plate 5, wherein the holding section 640 can be designed in a manner corresponding to the extension section in FIGS. 4-8.

Attention is furthermore drawn to the fact that it is also possible in a corresponding manner for a fastening element 60 comprising a fastening section and a holding section in the manner described to be arranged on the radially inner platform.

It will be understood that the invention is not limited to the embodiments described above, and various modifications and improvements can be made without departing from the concepts described herein. For example, the invention has been described above by means of exemplary embodiments in which the adjoining component is arranged upstream of the guide vane segments 4, and the extension section 62 of the sealing strip 6 accordingly extends axially forward. In a corresponding manner, provision can be made for the extension section to extend axially rearward in order to hold sealing plates which seal off the guide vane segments 4 from a component adjoining the guide vane segments in a downstream direction. It is furthermore possible, for example, for the sealing strip 6 to form a sealing section 61 and an extension section 62 only on the outer platform 41 or only on the inner platform 42, rather than on both platforms 41, 42.

Furthermore, except where mutually exclusive, any of the features may be used separately or in combination with any other features, and the disclosure extends to and includes all combinations and sub-combinations of one or more features that are described herein. If ranges are defined, said ranges thus comprise all of the values within said ranges as well as all of the partial ranges that lie in a range.

1. A device for fastening sealing plates between components of a gas turbine engine, wherein the device has:
a guide vane ring which comprises a plurality of guide vane segments, wherein
each guide vane segment comprises an outer plate, an inner platform and at least one guide vane,
the outer platforms and the inner platforms of in each case two adjacent guide vane segments adjoin one another at the ends, and,
in this arrangement, in each case two platforms are sealed off from one another at the ends by means of a sealing strip, wherein the platforms each form an axially extending groove at their ends, and the sealing strip is inserted into the grooves of the platforms, and wherein the sealing strip extends in the grooves from the axially forward end of the platforms to the axially rearward end of the platforms,
a plurality of sealing plates which seal off the guide vane segments from a component which adjoins the guide vane segments in the upstream or downstream direction,
wherein
in that the sealing strips in each case form a sealing section and an extension section in the region of the outer and/or the inner platforms, wherein
the sealing section serves to seal off two mutually adjoining platforms,
the extension section extends axially forward, starting from the sealing section, and projects from the platforms, and
the extension section forms a holding element for at least one sealing plate or is connected to a separate holding element.

2. The device as claimed in claim 1, wherein in that the sealing section of a sealing strip is in each case inserted into the grooves of two adjacent platforms, wherein the extension section projects from the grooves in the downstream direction.

3. The device as claimed in claim 1, wherein the extension section is of wider design in the circumferential direction than the sealing section.

4. The device as claimed in claim 1, wherein the extension section forms a section which extends substantially in the radial direction and in the circumferential direction and is of flat design,

5. The device as claimed in claim 1, wherein the extension section forms a groove which extends in the circumferential direction and is used to retain and accommodate at least one adjoining sealing plate.

6. The device as claimed in claim 5, wherein the section which extends substantially in the radial direction and in the circumferential direction is bent back at its radially outer end and thereby forms a groove.

7. The device as claimed in claim 5, wherein the extension section has a length in the circumferential direction such that two adjacent sealing plates can be inserted into the groove of the extension section.

8. The device as claimed in claim 1, wherein the extension section is connected to a holding element for at least one sealing plate, said holding element being designed as a separate part.

9. The device as claimed in claim 8, wherein the holding element forms a section which extends substantially in the radial direction and in the circumferential direction, is of flat design and is bent back at its radially outer end and thereby forms a groove extending in the circumferential direction.

10. The device as claimed in claim 1, wherein the extension section is of resilient design and exerts a spring force on at least one of the sealing plates.

11. The device as claimed in claim 10, wherein the extension section forms a region bent in a U shape or a region bent in a meandering shape.

12. The device as claimed in claim 10, wherein the extension section is of resilient design and exerts an axially acting spring force on the holding element.

13. The device as claimed in claim 1, wherein radial noses which fix the sealing plates in the circumferential direction in relation to the holding elements are formed on said sealing plates.

14. The device as claimed in claim 13, wherein the radial noses are formed at a distance from the lateral ends of the sealing plates and adjoin the respectively adjacent holding element on the outside in the circumferential direction.

15. The device as claimed in claim 1, wherein the guide vane ring is a turbine guide vane ring, wherein the sealing plates are designed to seal off the turbine guide vane ring from a combustion chamber arranged upstream.

16. The device as claimed in claim 1, wherein the sealing strips are composed of a metal or a metal alloy.

17. A gas turbine engine which comprises a combustion chamber and a turbine guide vane ring arranged downstream of the combustion chamber, wherein the device as claimed in claim 1, by means of which sealing plates provided between the combustion chamber and the turbine guide vane ring are fastened.

18. A device for fastening sealing plates between components of a gas turbine engine, wherein the device has:
a guide vane ring which comprises a plurality of guide vane segments, wherein
each guide vane segment comprises an outer platform, an inner platform and at least one guide vane,
the outer platforms and the inner platforms of in each case two adjacent guide vane segments adjoin one another at the ends, and,
in this arrangement, in each case two platforms are sealed off from one another at the ends by means of a sealing strip, wherein the platforms each form an axially extending groove at their ends, and the sealing strip is inserted into the grooves of the platforms, and wherein the sealing strip extends in the grooves from the axially forward end of the platforms to the axially rearward end of the platforms,
a plurality of sealing plates which seal off the guide vane segments from a component which adjoins the guide vane segments in the upstream or downstream direction,
wherein
in that a respective fastening element for at least one sealing plate is provided in the region of the outer and/or the inner platforms, wherein the fastening element holds the at least one sealing plate or is connected to a separate holding element, which holds the at least one sealing plate, wherein the fastening element has:
a fastening section, which is arranged together with the sealing strip in the grooves of two adjacent platforms and is held in said grooves, and
a holding section, which extends axially forward, starting from the fastening section, and projects from the platforms in order to hold the at least one sealing plate or to be connected to the separate holding element.

19. The device as claimed in claim 18, wherein the fastening section is arranged only in an axially forward partial region of the grooves.

20. The device as claimed in claim 18, wherein the axially forward partial region of the grooves is widened relative to a downstream region of the grooves.

21. The device as claimed in claim 18, wherein the holding section is of resilient design and exerts a spring force on at least one of the sealing plates.

22. The device as claimed in claim 18, wherein the holding section is of resilient design and exerts a spring force on the separate holding element which holds the at least one sealing plate.

23. The device as claimed in claim 18, wherein the holding section forms a region bent in a U shape or a region bent in a meandering shape.

24. The device as claimed in claim 18, wherein the holding section is of wider design in the circumferential direction than the fastening section.
